(19) United States
(12) Patent Application Publication
(10) Pub. No.: US 2012/0063791 A1
(43) Pub. Date: Mar. 15, 2012

(54) PRINTING APPARATUS AND CONTROLLING METHOD THEREFOR

(75) Inventors: Tsutomu Iwanaga, Kitakyushu-shi (JP); Kazuya Yoshikaie, Kitakyushu-shi (JP)

(73) Assignee: SEIKO EPSON CORPORATION, Shinjuku-ku (JP)

(21) Appl. No.: 13/232,871

(22) Filed: Sep. 14, 2011

(30) Foreign Application Priority Data
Sep. 14, 2010 (JP) 2010-205456

(51) Int. Cl. G03G 15/00

(52) U.S. Cl. 399/21

(57) ABSTRACT

The printing apparatus includes a transport mechanism that feeds the recording medium to a printing position along a transport route, a carriage disposed so as to oppose the recording medium placed on the printing position, and a driving unit that drives the carriage to reciprocate in a main scanning direction different from the transport direction of the recording medium. The carriage moves when the front edge of the recording medium reaches a predetermined position on the transport route, and jam detection is performed by deciding whether the recording medium is jammed, on the basis of a physical amount that changes with the movement of the carriage.

The present invention contains subject matter related to Japanese Patent Application No. 2010-205456 filed in the Japanese Patent Office on Sep. 14, 2010, the entire contents of which are incorporated herein by reference.

### BACKGROUND

1. Technical Field

The present invention relates to a printing apparatus that applies a recording agent to a recording medium transported along a predetermined transport route from a carriage that performs scanning strokes, and a method of controlling the printing apparatus.

2. Related Art

In a printing apparatus that prints an image on a recording medium transported along a transport route, what is known as a jam sometimes occurs where the recording medium deviates from the transport route because the recording medium warps or becomes distorted, and thereby becomes caught in the apparatus. Accordingly, various techniques for promptly detecting a jam have been proposed. For example, JP-A-2005-178268 (for example FIG. 5) proposes utilizing fluctuation of load on a carriage having a recording head that reciprocates in a main scanning direction orthogonal to the direction in which the recording medium is transported (hereinafter, transport direction), for detecting a jam arising from contact between the carriage and the recording medium. More specifically, the apparatus monitors the value of the current used for driving the carriage, and decides that a jam has occurred when the value of the current exceeds a predetermined threshold.

The printing apparatus of this type feeds the recording medium to a position opposing the carriage and moves the carriage, thereby printing an image at a desired position on the recording medium. Accordingly, the recording medium may be transported without moving the carriage in order to place the recording medium at a desired position, depending on the nature of the image to be printed. However, the conventional technique cited above utilizes load fluctuation during the scanning motion of the carriage for printing an image on the recording medium, in order to detect a jam. Such a method is naturally unable to detect a jam that occurs while the recording medium is being transported without moving the carriage.

### SUMMARY

An advantage of some aspects of the invention is that a printing apparatus is provided that includes a carriage driven to reciprocate so as to print an image on a recording medium, and is capable of more accurately detecting a jam that occurs while the recording medium is being transported.

In an aspect, the invention provides a printing apparatus including a transport mechanism that feeds a recording medium to a printing position along a predetermined transport route, a printing unit including a carriage disposed so as to oppose the recording medium placed at the printing position and a driving unit that drives the carriage to reciprocate in a main scanning direction different from a direction in which the recording medium is transported along the transport route, the printing unit being configured to apply a recording agent from the carriage to the recording medium to thereby print an image on the recording medium, and a controller that causes the driving unit to drive the carriage to make a scanning motion without supplying the recording agent from the carriage when a transport distance of the recording medium from a transport starting position from which it is possible for the transport mechanism to transport the recording medium becomes equal to a predetermined specified distance, and decides whether a jam of the recording medium has occurred on the basis of a physical amount that changes along with the movement of the carriage, wherein the specified distance corresponds to the transport distance of the recording medium that allows at least a part of the recording medium to oppose the carriage when the carriage makes a scanning motion.

In another aspect, the invention provides a method of controlling a printing apparatus that includes a transport mechanism that feeds a recording medium from a transport starting position to a printing position along a predetermined transport route and a carriage that reciprocates in a main scanning direction different from a direction in which the recording medium is transported, and that applies a recording agent from the carriage to the recording medium placed at the printing position to thereby print an image on the recording medium. The method includes causing the driving unit to drive the carriage to make a scanning motion without supplying the recording agent from the carriage in the case where a transport distance of the recording medium from a transport starting position that enables the transport mechanism to transport the recording medium becomes equal to a predetermined specified distance, and deciding whether a jam of the recording medium has occurred on the basis of a physical amount that changes along with the movement of the carriage, wherein the specified distance corresponds to the transport distance of the recording medium that allows at least a part of the recording medium to oppose the carriage when the carriage makes a scanning motion.

The term “specified distance” means that “when the carriage is caused to move upon transporting the recording medium by the specified distance from the transport starting position along the transport route, a period is made in which the moving carriage and the recording medium oppose each other”. In the printing apparatus thus configured, the carriage is caused to move when the transport distance of the recording medium from the transport starting position becomes equal to the specified distance, irrespective of whether a printing action is to be made, and occurrence of a jam is detected on the basis of a physical amount that changes with the movement of the carriage. Here, the specified distance is determined such that at least a part of the recording medium is located opposite the carriage as stated above. Thus, in the case where the recording medium bears a cause of a jam such as warp or distortion, the recording medium contacts the carriage at this moment, and such contact can be detected as a change in the physical amount based on the movement of the carriage. The foregoing printing apparatus can therefore accurately detect a jam of the recording medium, including a jam that the conventional technique is unable to detect because the carriage is not in motion while the recording medium is transported.

It is preferable that the specified distance of the printing apparatus is shorter than, for example, a transport distance of the recording medium necessary for a rear edge of the recording medium in the transport direction to be released from being transported by the transport mechanism. Such an arrangement allows detection of a jam before the rear edge of the recording medium is released from the transport mechanism, thereby allowing the recording medium to be discharged by the transport mechanism in a case where a jam has occurred.

In the case where the printing apparatus includes a delivery mechanism that delivers the recording medium that has passed the printing position along the transport route, the specified distance may be longer than a transport distance of the recording medium necessary for a front edge thereof in the transport direction along the transport route to reach the delivery mechanism. Such an arrangement allows a jam to be detected at an early stage in a case where the front edge of the recording medium has not normally reached the delivery mechanism.

Alternatively, the specified distance may be determined by adding a predetermined margin amount to the transport distance of the recording medium necessary for the front edge thereof in the transport direction along the transport route to reach the delivery mechanism. The recording medium inevitably suffers slight warp or distortion during the transport, however setting the specified distance including the margin amount as above allows such slight deformation to be absorbed. According to an experiment performed by the present inventors, a preferable margin amount is half to twice a distance between a downstream end portion of the carriage in the transport direction and the delivery mechanism.

Preferably, the controller may detect a jam while the carriage is being driven by the printing unit to print an image on the recording medium, independently from the foregoing jam detection. Such an arrangement allows a jam that occurs before the transport distance of the recording medium reaches the specified distance to be properly handled.

For example, the printing apparatus may include a detector that detects as a physical amount at least one of a driving torque of the driving unit for driving the carriage, power consumption of the driving unit, and a traveling speed of the carriage, and the controller may decide that a jam has occurred when the detection result of the detector exceeds a threshold set for the corresponding physical amount. The cited physical amounts may significantly vary when the carriage is disturbed from moving by contact with the recording medium compared with the state where the carriage is moving without contacting the recording medium. These physical amounts can therefore be suitably adopted in the jam detection.

For example, the transport mechanism may transfer the recording medium in a direction opposite to the transport direction when the controller decides that a jam has occurred as a result of jam detection. Such an arrangement prevents the recording medium from proceeding further into the apparatus thereby making the jammed state more serious, and allows the recording medium to be discharged to the side of the transport starting position.

Further, the method of controlling a printing apparatus may include printing an image corresponding to the printing data on the recording medium by alternately repeating transporting the recording medium by using the transport mechanism and causing the carriage to perform a scanning motion, while determining the transport distance by using the transport mechanism on the basis of printing data, and causing the transport mechanism to transport the recording medium such that the transport distance of the recording medium from the transport starting position becomes equal to the specified distance for detecting a jam, in the case where transporting the recording medium by the transport distance determined on the basis of the printing data results in the transport distance of the recording medium from the transport starting position exceeding the specified distance.

During the printing operation, an increment of the transport distance of the recording medium may increase and the transport distance may exceed the specified distance depending on the nature of the image to be printed. In this case, the printing apparatus may fail to detect a jam at an early stage. However, early detection of a jam becomes possible by transporting the recording medium once to the position where the transport distance becomes equal to the specified distance for detecting a jam, in the case where the transport distance determined on the basis of the printing data makes the recording medium proceed in excess of the specified distance.

### BRIEF DESCRIPTION OF THE DRAWINGS

The invention will be described with reference to the accompanying drawings, wherein like numbers reference like elements.

FIG. 1 is a side view of an essential part of a photo printer according to an embodiment of the invention.

FIG. 2 is a block diagram showing an electrical configuration of the photo printer shown in FIG. 1.

FIG. 3 is a flowchart showing a printing operation according to the embodiment.

FIG. 4 is a schematic diagram showing a paper transport process in the printing operation.

FIG. 5 is a flowchart showing a jammed paper discharge operation.

FIG. 6 is a first diagram for explaining the principle of programmed jam detection.

FIGS. 7A to 7D are second diagrams for explaining the principle of programmed jam detection.

FIGS. 8A and 8B are graphs for explaining an experiment performed to determine a margin amount.

FIG. 9 is a flowchart showing an activation process according to the embodiment.

### DESCRIPTION OF EXEMPLARY EMBODIMENTS

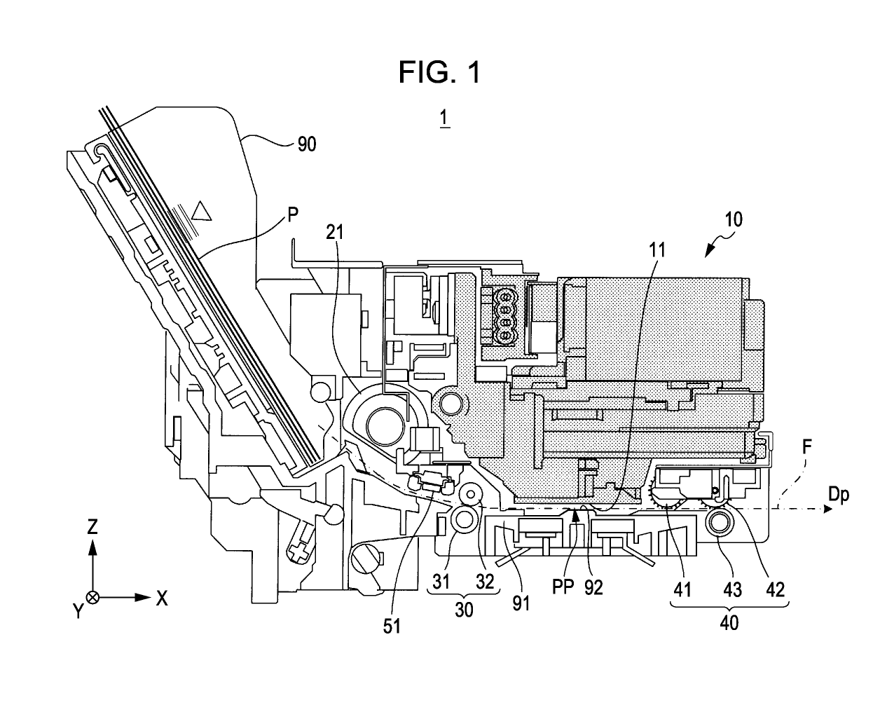

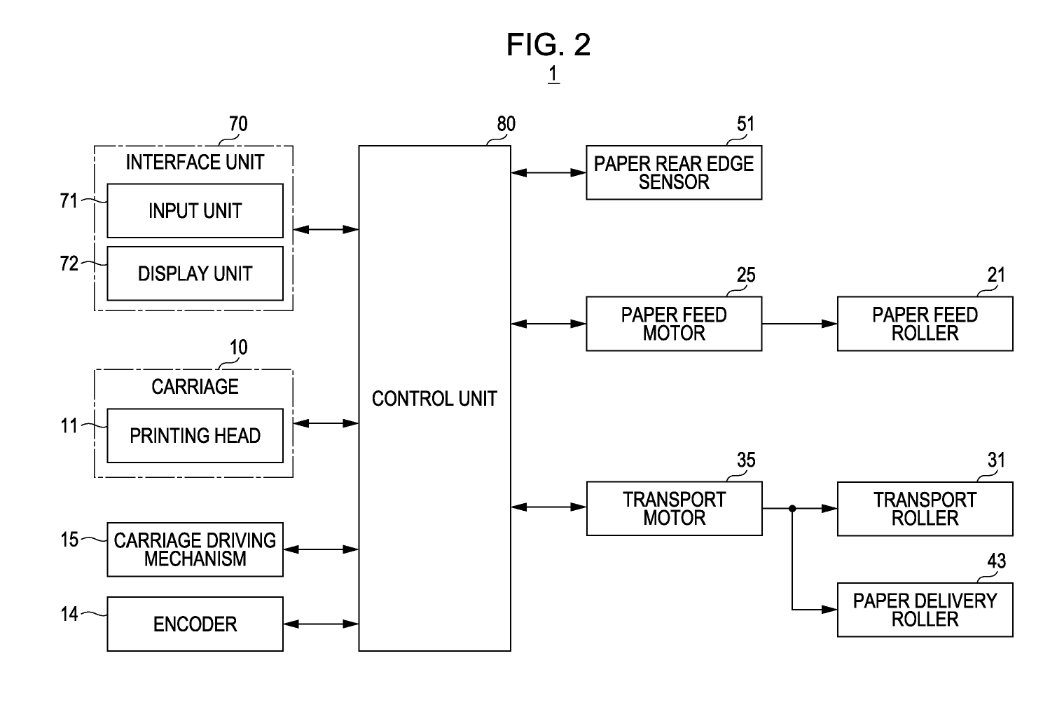

FIG. 1 is a side view of an essential part of a photo printer exemplifying the printing apparatus according to the invention. FIG. 2 is a block diagram showing an electrical configuration of the photo printer shown in FIG. 1. For the sake of convenience in the subsequent description, coordinate directions X, Y, and Z will be defined as indicated in FIG. 1.

The photo printer 1 transports paper sheets P exemplifying the recording medium placed in a paper feed tray 90 along a predetermined transport route F one by one. The photo printer 1 discharges an ink exemplifying the recording agent from a printing head 11 provided at a central portion of a lower face of a carriage 10 that reciprocates in a main scanning direction orthogonal to the transport direction Dp of the paper in accordance with the printing data, thereby forming an image corresponding to the printing data on the paper P. The configuration of the photo printer 1 will be described in detail here below.

A paper feed roller 21, a transport roller 31, and a paper delivery roller 43 are disposed in this order from an upstream side of the paper transport direction Dp along the transport route F, and the paper P is transported along the transport route F by those rollers operating under the control of a control unit 80. More specifically, the paper feed roller 21 has a circular cross-sectional shape with an outer circumferential portion thereof partially cut away, and is driven so as to rotate by a paper feed motor 25. When the paper feed motor 25 rotates in accordance with an instruction from the control unit 80, the paper feed roller 21 rotates and contacts a surface of the uppermost sheet of the paper P placed on the paper feed tray 90, so that a sheet of paper P is introduced into the transport route F.

The paper P introduced into the transport route F by the paper feed roller 21 is moved forward to a printing position PP right under the printing head 11 by a transport mechanism 30 located downstream of the paper feed roller 21 in the paper transport direction Dp. The transport mechanism 30 includes the transport roller 31 and a slave roller 32 disposed so as to oppose each other across the transport route F, and the transport roller 31 is driven so as to rotate by a transport motor 35. When the paper feed motor 35 rotates in accordance with an instruction from the control unit 80, the paper P is moved forward to the printing position PP through a transport nip formed at the contact point between the transport roller 31 and the slave roller 32.

A paper rear edge sensor 51 is provided that detects whether the paper P is present on the transport route F in a region downstream of the paper feed roller 21 and upstream of the transport mechanism 30. As will be subsequently described in further detail, the paper rear edge sensor 51 primarily serves to detect whether the rear edge of the paper P with respect to the transport direction Dp has passed the corresponding position in this embodiment. The paper rear edge sensor 51 may be exemplified by an optical sensor such as a reflective photosensor or a photo interrupter, and a mechanical sensor such as a micro switch.

The carriage 10 and a paper guide 91 are disposed so as to oppose each other with a predetermined gap therebetween across the transport route F at the printing position PP. The carriage 10 is driven to reciprocate in the main scanning direction (direction Y in FIG. 1) by a carriage driving mechanism 15 under the control of the control unit 80. While the carriage 10 is moving the ink is discharged from the printing head 11 in accordance with the printing data, so that the ink adheres to the paper P passing the printing position PP thus forming an image corresponding to the printing data. At the printing position PP, a portion of the upper surface of the paper guide 91 opposing the printing head 11 slightly protrudes toward the carriage 10 and constitutes a backup portion 92 that sustains the portion of the paper P receiving the ink. The printing may be performed by a known ink jet printing method, but applicable methods are not limited thereto. In FIG. 1, the portion corresponding to the carriage 10 that integrally performs the scanning motion is shaded with dots for clearer distinction from the remaining portions.

Through a one-way scanning motion of the carriage 10, an image strip having a width corresponding to the size of the printing head 11 in the direction X is formed on the paper P. Accordingly, alternately repeating the transport of the paper P to the printing position PP with the transport mechanism 30 and the scanning motion of the carriage 10 leads to formation of a two-dimensional image on the paper P.

In this embodiment, the photo printer 1 includes an encoder 14 that detects the position of the carriage 10 in the main scanning direction, as shown in FIG. 2. For example, a linear encoder that outputs information indicating the position of the carriage 10 in the apparatus, or a rotary encoder that outputs a rotational phase of a motor (not shown) provided in the carriage driving mechanism 15 thereby indirectly indicating the position of the carriage 10 can be employed as the encoder 14. The control unit 80 recognizes the position of the carriage 10 on the basis of the output of the encoder 14, as well as the traveling speed of the carriage 10 from a pulse output interval from the encoder 14 synchronized with the movement of the carriage 10.

Upon passing the printing position PP, the paper P is transported further by the transport roller 31 and introduced into a delivery mechanism 40 provided downstream of the printing position PP in the paper transport direction Dp. The delivery mechanism 40 includes a first serrated roller 41 and a second serrated roller 42 aligned on the transport route F so as to rotate about an axis parallel to the direction Y, and a paper delivery roller 43 disposed so as to oppose the second serrated roller 42 across the transport route F. The paper delivery roller 43 is driven so as to rotate by the transport motor 35. Accordingly, the transport roller 31 and the paper delivery roller 43 rotate while interlocked with each other. A multitude of projections are formed on the surface of the first and the second serrated roller, to reduce the contact area with respect to the surface (printed surface) of the paper P which has just been printed, to thus prevent the image from becoming dirty. The paper P is outputted to a paper delivery tray (not shown) by the thus-configured delivery mechanism 40, after passing the printing position PP.

The photo printer 1 also includes an interface 70 including an input unit 71 and a display unit 72, as shown in FIG. 2. The input unit 71 includes an input interface that receives data from a storage medium or an external device that stores images, and a keyboard and buttons for accepting an input operation by a user, and transmits such inputted information to the control unit 80. The display unit 72 includes a screen, for example constituted of an LCD panel, and displays visual information to be provided to the user such as a preview image of the image to be printed, an operation guide, and an error message, in accordance with an instruction from the control unit 80.

In FIG. 1, the right side corresponds to the front face of the photo printer 1, and the left side corresponds to the rear face thereof. Accordingly, the paper P is introduced into the apparatus from the paper feed tray 90 provided at an upper position in the rear side of the apparatus and printing is performed on the paper P, which is then outputted to the paper delivery tray on the front side of the apparatus.

Hereafter, a printing operation performed by the thus-configured photo printer 1 will be described. Upon receipt of a printing instruction from the user or an external host computer, the control unit 80 in the photo printer 1 generates printing data based on the instruction and controls the above-described constituents of the photo printer 1 so as to execute the printing operation, to thus print the designated image on the paper P.

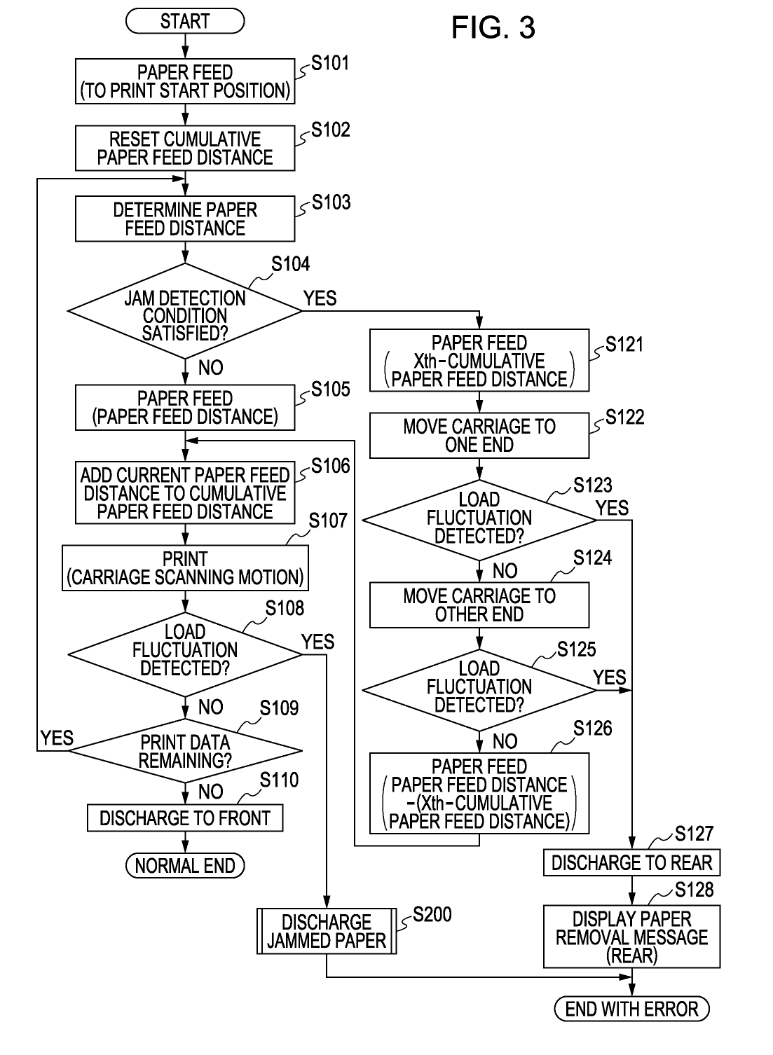

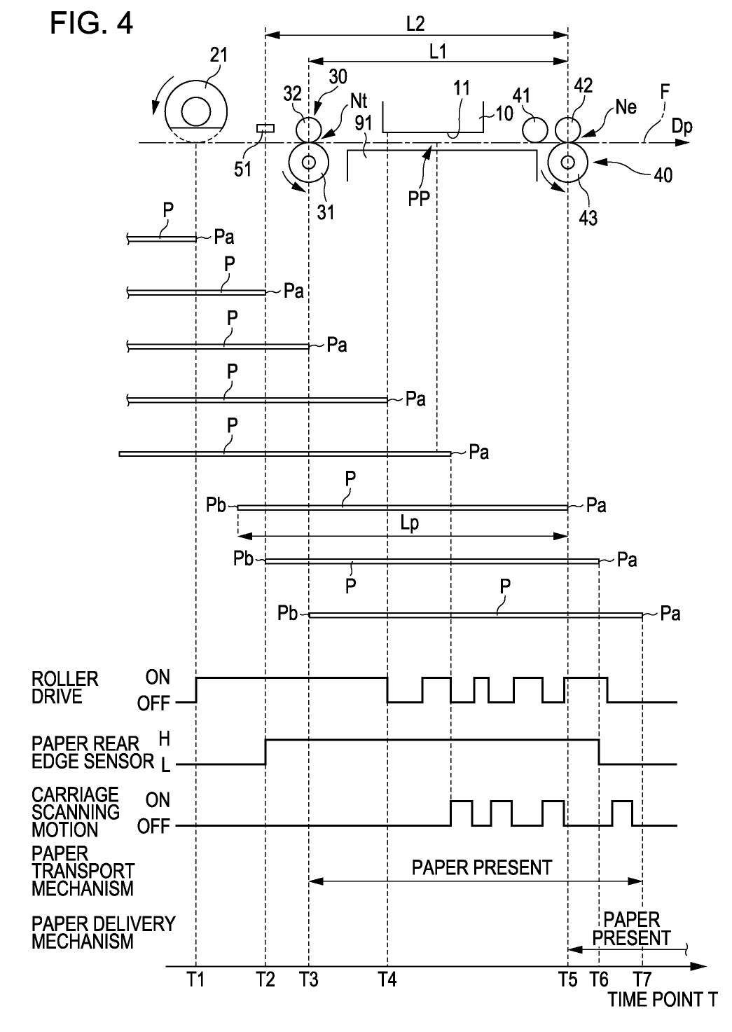

FIG. 3 is a flowchart showing a printing operation according to this embodiment. FIG. 4 is a schematic diagram showing a paper transport process in the printing operation. In FIG. 4, the transport route F which is actually curved is indicated by a straight line, and the shapes of the constituents are simplified, for better understanding. Although the printing operation shown in FIG. 3 includes deciding whether a predetermined condition for starting jam detection is satisfied (step S104) and the jam detection performed when that condition is satisfied (steps S121 to S128), these steps will be subsequently described in detail. The remaining part of the printing operation will be first described, for the sake of clearer understanding.

First, a sheet of paper P is introduced into the print starting position from the paper feed tray 90 (step S101). More specifically, the paper feed roller 21 is made to rotate to thereby pick up a sheet of paper P from the paper feed tray 90, and the transport mechanism 30 transports the paper P to the print starting position. The print starting position is a position where the front edge Pa of the paper P in the transport direction Dp slightly intrudes in a region opposing the lower face of the carriage 10.

As shown in FIG. 4, the paper feed roller 21 and the transport roller 31 are driven so as to rotate at a time point T1, and the paper rear edge sensor 51 outputs a HIGH level signal indicating that the paper is present, at a time point T2 at which the paper front edge Pa reaches a detection position right under the paper rear edge sensor 51. After a time point T3 at which the paper front edge Pa reaches the transport nip Nt defined by the transport roller 31 and the slave roller 32, the transport roller 31 is made to rotate so as to transport the paper P, until the rotation of the rollers is temporarily stopped at a time point T4 at which the paper front edge Pa reaches the print starting position under the carriage 10.

At this point, the control unit 80 resets “cumulative paper feed distance” which is one of internal parameters (step S102). In other words, the cumulative paper feed distance at this time point is returned to zero. The cumulative paper feed distance is an internal parameter indicating how far the paper front edge Pa has been transported along the transport route F with respect to the print starting position, and indicating the current position of the paper P on the transport route F. Here, the paper feed distance, i.e., the transport distance of the paper P along the transport direction F may be obtained, for example, from the number of rotations of the transport roller 31 or the number of driving pulses applied to the transport motor 35.

Then the paper feed roller 21 is stopped, and the transport motor 35 rotates the transport roller 31 and paper delivery roller 43 to thereby transport the paper P along the transport route F, and the carriage 10 is driven so as to move each time the paper P is moved forward, so that printing is performed. In this process, the paper transport distances (paper feed distances) realized by each transporting action of the transport roller 31 are not uniform but are dynamically determined on the basis of the position of the image to be printed. More specifically, the control unit 80 calculates a distance along the transport route F between the current position of the paper P and a position where the next printing action is to be performed, on the basis of the printing data corresponding to the image to be formed, and determines the paper feed distance in accordance with the calculated distance (step S103).

In the case of printing an image containing a continuously extending portion in the transport direction Dp such as a photographic image, the paper P may be transported by a constant increment corresponding to the size of the printing head 11 in the direction X. In contrast, when printing an image in which portions to be printed are intermittently located such as a text image including wide spaces between letters or lines, the paper feed distance may be dynamically determined so as to transport the paper P in a larger increment at a time, which allows a reduction in printing time.

The step S104 will be described later in detail. The paper P is then moved forward in the transport direction Dp by the paper feed distance determined as above (step S105). Accordingly, a region on the paper P where a part of the image is to be printed is located right under the printing head 11. At the same time, the control unit 80 adds the paper feed distance covered by this action to the cumulative paper feed distance, thus updating the cumulative paper feed distance (step S106). Then the carriage 10 is driven to move in the main scanning direction and the ink is discharged from the printing head 11 in accordance with the printing data, thereby performing printing (step S107). At this point, a new image strip is printed on the paper P.

Then jam detection is performed on the basis of load fluctuation of the carriage driving mechanism 15 (step S108). More specifically, it is decided that the load has fluctuated when the interval of the pulses outputted from the encoder 14 in synchronization with the movement of the carriage 10 exceeds a predetermined threshold. In a case where a paper jam has occurred between the carriage 10 and the paper guide 91, the load to be borne by the carriage driving mechanism 15 increases because of contact between the carriage 10 and the paper P. Thus, the increase in the load on the carriage driving mechanism 15 can be construed as an indication of the occurrence of a jam between the carriage 10 and the paper guide 91. In this embodiment, the interval between the output pulses of the encoder 14 indicating the traveling speed of the carriage 10 is utilized for jam detection, in view of the fact that, although the carriage driving mechanism 15 drives the carriage 10 to travel at a constant speed, the traveling speed of the carriage 10 is reduced when the load increases owing to a jam. It is to be noted that the jam detection performed during the printing operation utilizing the carriage load fluctuation will be hereinafter referred to as “in-operation jam detection” so as to be distinguished from “programmed jam detection” to be subsequently described.

To detect a jam, for example the technique according to JP-A-2005-178268 disclosed earlier by the present applicant may also be employed. Specifically, although in this embodiment the interval between the output pulses of the encoder 14 indicating the traveling speed of the carriage 10 is utilized for jam detection among the physical amounts that fluctuate with traveling of the carriage 10, other physical amounts, for example the energy consumed by the carriage driving mechanism 15 (current consumption or power consumption) and driving torque for the carriage 10 may be employed for detecting a jam.

Alternatively, jam detection may be performed on the basis of fluctuation of load to be borne by the transport motor 35, instead of the carriage driving mechanism 15. In short, it is preferable to select a physical amount that significantly fluctuates when the carriage 10 or the paper P is disturbed from moving because of contact therebetween, compared with the state where the paper P is normally transported along the transport route F without contacting the carriage 10, and to set as a threshold a greater value than a range that the physical amount is supposed to assume in the normal operation, to thereby make it possible to decide that a jam has occurred when the physical amount exceeds the threshold. Conversely, a threshold lower than a normal range may be set with respect to a physical amount that significantly decreases when a jam occurs, to thereby make it possible to decide that a jam has occurred when the physical amount falls below the threshold.

A jammed paper discharge operation (step S200) performed when a jam is detected will be subsequently described. If a jam is not detected, it is decided whether there is an unprinted part to be printed on the paper P remaining in the printing data (step S109), and in the affirmative case the process from the step S103 to the step S108 is repeated, while in the negative case the printing on the paper P is assumed to have been normally completed, and the paper delivery roller 43 is made to rotate to thereby output the paper P that has completely undergone the printing operation to the paper delivery tray provided on the front side of the photo printer 1 (step S110). Through these steps, the paper feed operation performed by the transport roller 31 and the paper delivery roller 43 and the printing performed while the carriage 10 is being moved are alternately executed as shown in FIG. 4.

It is preferable to set the positional relationship among the constituents of the photo printer 1 so as to satisfy the following conditions. Unlike large-sized printers, there is a strong demand for small printers such as the photo printer 1 to be reduced in size and weight, and hence it is difficult to adopt a structure that allows the transport route to be exposed for the purpose of removing a jammed paper sheet. In this embodiment, therefore, the structure and operation sequence of the constituents are determined such that, first, a jam that makes it impossible for paper caught in the apparatus to be removed outwardly is least likely to occur and, second, the paper can be discharged out of the apparatus if a jam should occur.

First, it is preferable that the time point T7 at which the paper rear edge Pb is released from the transport nip Nt be preceded by the time point T5 at which the paper front edge Pa reaches a paper delivery nip Ne formed between the paper delivery roller 43 and the second serrated roller 42, in other words that at least a part of the paper P remain in the transport nip Nt when the paper front edge Pa reaches the paper delivery nip Ne. Specifically, it is preferable that a length L1 of the transport route F between the transport nip Nt and the paper delivery nip Ne be shorter than a paper length Lp in the transport direction Dp. This is because once the rear edge Pb is released from the transport nip Nt before the paper front edge Pa is engaged with the paper delivery nip Ne, a transporting force can no longer be applied to the paper P to introduce the paper P into the paper delivery nip Ne. Such a configuration allows the paper P to be pinched by both of the transport nip Nt and the paper delivery nip Ne during the period from T5 to T7 in a normal paper feed operation, thereby ensuring that the transporting force is applied to the paper P.

More preferably, a length L2 of the transport route F between the detection position and the paper delivery nip Ne may be shorter than the paper length Lp in the transport direction Dp, so that the time point T6 at which the paper rear edge Pb passes the position corresponding to the paper rear edge sensor 51 comes slightly after the time point T5. In this case, the paper front edge Pa can reach the paper delivery nip Ne by the time point T6 at which the output of the paper rear edge sensor 51 falls from a HIGH level to a LOW level, in a normal paper feed operation.

Accordingly, unless a jam occurs before the output of the paper rear edge sensor 51 falls from a HIGH level to a LOW level, it can be assumed that at least the paper front edge Pa has reached the paper delivery nip Ne, and even if a jam occurs after this time point it is unlikely that the jam will have arisen from abnormal transport of the paper front edge Pa. For example, in a case where the paper rear edge Pb is warped or bent a jam may occur at this stage. Conversely, in a case where a jam occurs before the time point T6, it can be assumed that the paper front edge Pa has not properly reached the paper delivery nip Ne.

Thus, making the length L2 of the transport route F between the detection position of the paper rear edge sensor 51 and the paper delivery nip Ne shorter than the paper length Lp in the transport direction Dp allows a position of a jam to be presumed with considerable accuracy. Accordingly, the jammed paper discharge operation (step S200) to be performed when a jam is detected during the printing operation is arranged as follows in this embodiment.

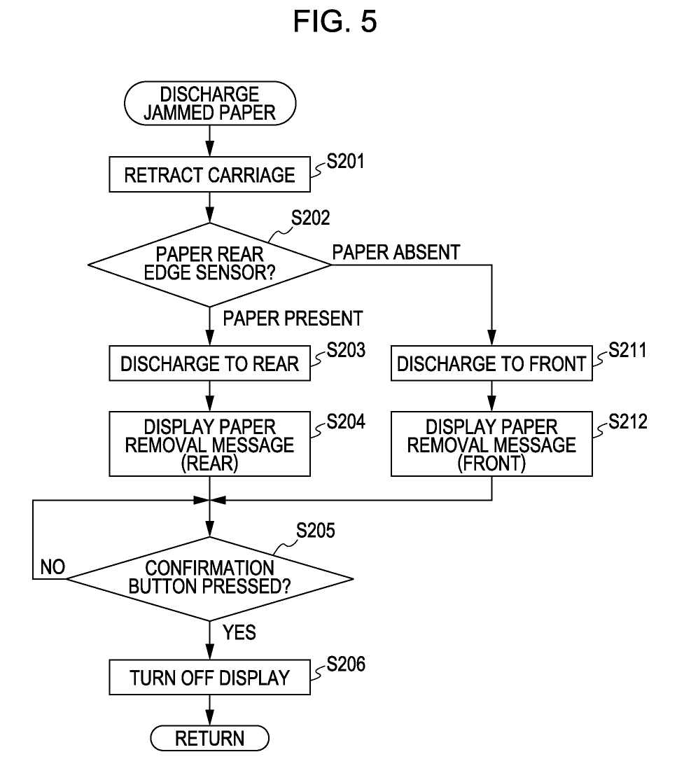

FIG. 5 is a flowchart showing the jammed paper discharge operation. Once a jam is detected from load fluctuation of the carriage 10, the carriage 10 is immediately retracted (step S201). More specifically, the scanning motion of the carriage 10 is suspended, and then the carriage 10 is moved in a direction opposite to the travel direction at that moment and retracted to a home position where the carriage 10 can be kept from interfering with the paper P. Such an arrangement prevents the paper P and the apparatus from suffering further damage originating from a jam.

Then the output of the paper rear edge sensor 51 is checked (step S202). Since the paper rear edge sensor 51 is located upstream of the transport nip Nt in the transport direction Dp (left side in FIG. 1), the paper P must be present in the transport nip Nt as long as the paper rear edge sensor 51 detects the presence of the paper P. This means that the paper P can be transported at least by the transport mechanism 30. Therefore, when the paper rear edge sensor 51 outputs a HIGH level (paper is present), the paper P is transported in a direction opposite to the normal transport direction Dp by the transport mechanism 30, and is discharged to the paper feed tray 90 on the rear side (step S203). Specifically, the rotation of the transport motor 35 is reversed so as to reverse the paper transport direction of the transport roller 31.

The display unit 72 is then caused to display a message (paper removal message) that urges the user to remove the paper discharged to the paper feed tray 90 on the rear side and to press a confirmation button (not shown) provided in the input unit 71 (step S204), and it is checked whether the confirmation button is pressed (step S205). Once the confirmation button is detected to have been pressed, the display of the paper removal message is erased (step S206) on the assumption that the paper that caused the jam has been removed, and the process is finished. The ending mode in this case is an end with an error (FIG. 3) which is different from the case where the operation has been normally completed. In this case, an activation process is performed before returning to the normal operation.

On the other hand, in the case where the paper rear edge sensor 51 has outputted a LOW level (no paper) at the step S202, it can be assumed that the jam has not occurred at least before the paper rear edge Pb passes the detection position of the paper rear edge sensor 51. Accordingly, most probably the paper front edge Pa has reached the paper delivery nip Ne before the occurrence of the jam. However, it cannot be uniquely decided whether the paper P is still in the transport nip Nt at this stage. In the case, therefore, the delivery mechanism 40 transports the paper P in the normal transport direction Dp, thereby discharging the paper P to the paper delivery tray on the front side (step S211).

The display unit 72 is then caused to display the paper removal message urging the user to remove the paper discharged to the paper delivery tray on the front side and to press the confirmation button provided in the input unit 71, and it is checked whether the confirmation button is pressed (step S212). The process after the confirmation button is pressed is the same as the case where the paper P is discharged to the rear side.

As described above, in the printing operation according to this embodiment a jam is detected by detecting fluctuation of the traveling speed of the carriage 10, and in a case where a jam occurs the paper discharge direction is determined on the basis of the output of the paper rear edge sensor 51 located upstream of the transport mechanism 30. Specifically, in the case where the paper rear edge sensor 51 indicates that the paper is present at the moment that the jam has occurred the rotation of the transport roller 31 is reversed to thereby discharge the paper P to the paper feed tray 90, opposite to the normal transport direction Dp. In contrast, in the case where the paper rear edge sensor 51 indicates that the paper is absent at the moment that the jam has occurred the paper delivery roller 43 is rotated forward to thereby discharge the paper P to the paper delivery tray in the normal transport direction Dp.

A technique according to JP-A-2002-068527 determines the paper discharge direction in a case of a jam on the basis of outputs from three sensors provided on the transport route, however according to this embodiment the output of a single sensor, namely the paper rear edge sensor 51, can perform the same function.

Referring again to FIG. 3, a jam detection process in the printing operation (steps S121 to S128) will be described. In this embodiment the jam detection is performed utilizing fluctuation of the traveling speed of the carriage 10, and hence the carriage 10 has to be driven to move in order to detect a jam. However, the paper P may be transported in a larger increment without moving the carriage 10, depending on the nature of the image to be printed or, for example, when the printing operation is cancelled halfway. In a case where a jam occurs under such a situation owing to warp or distortion of the paper P, the jam cannot be immediately detected, and the paper P and the apparatus may suffer a serious damage.

In this embodiment, accordingly, the carriage 10 is made to move, irrespective of whether a printing action is to be performed, when the cumulative paper feed distance of the paper P reaches a predetermined condition for starting jam detection, and fluctuation of the load to be borne by the carriage driving mechanism 15 is detected, to thereby detect at an early stage a jam that may occur. Here, for distinction from the “in-operation jam detection” performed during the printing operation, the jam detection described hereunder will be referred to as “programmed jam detection” because the detection is performed on the basis of a predetermined condition irrespective of whether a printing action is to be performed.

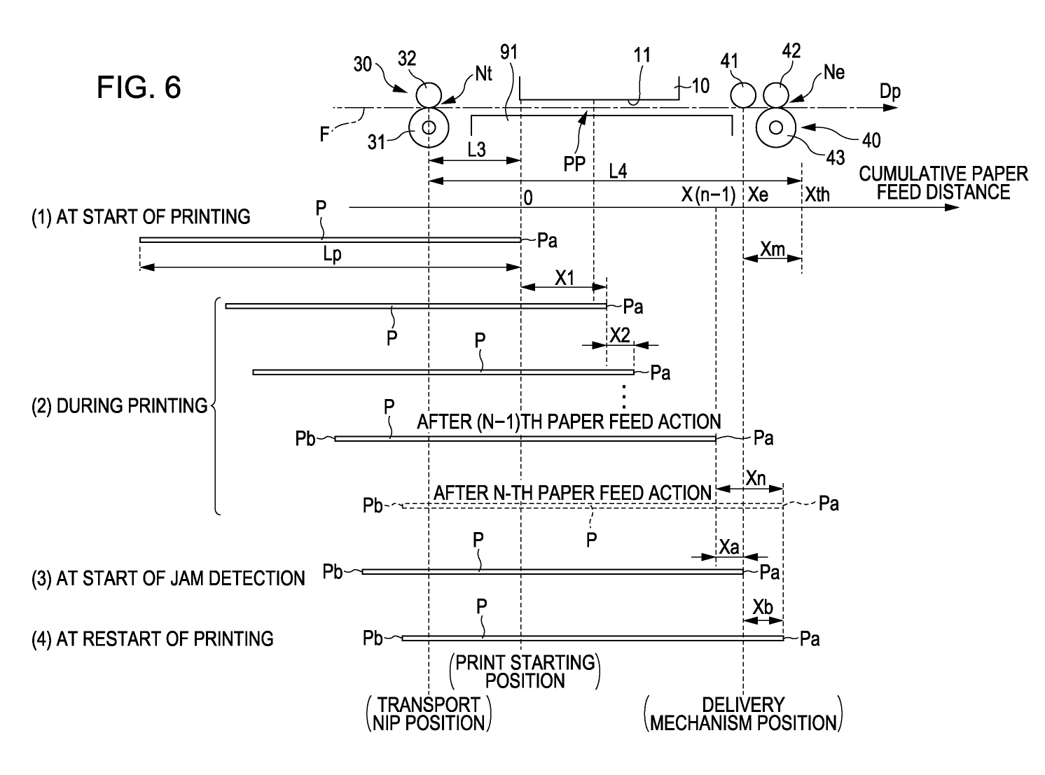

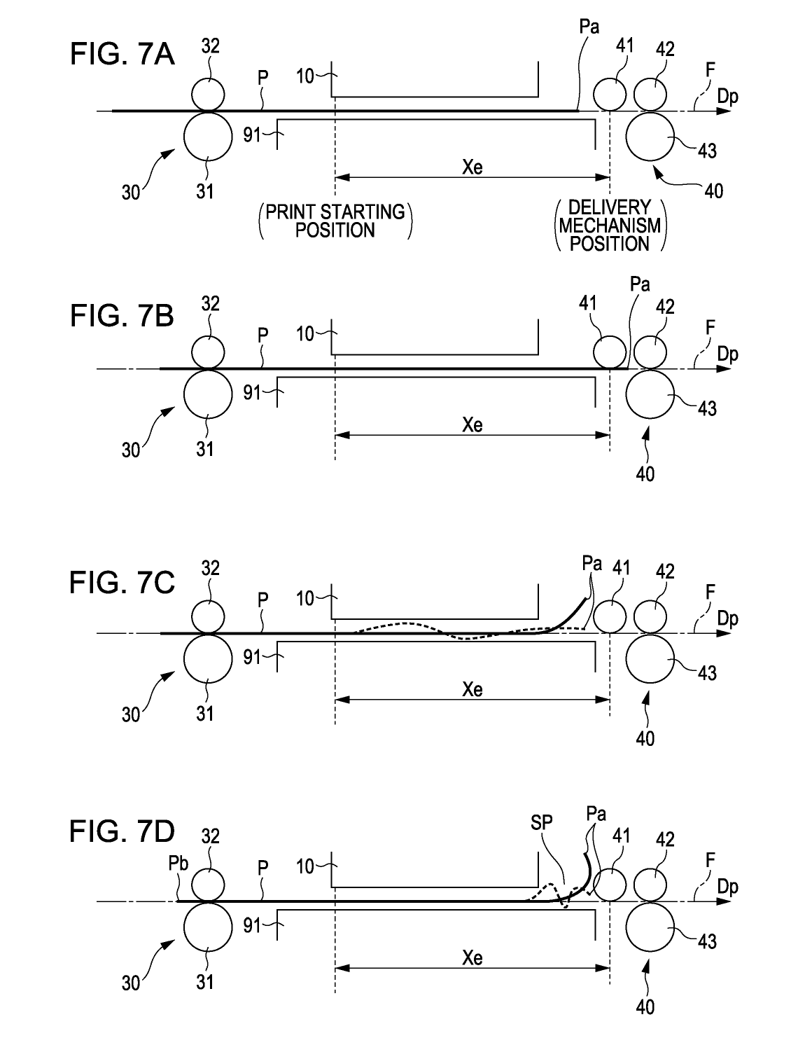

FIGS. 6 and 7A to 7D are diagrams for explaining the principle of the programmed jam detection. More specifically, FIG. 6 shows a relationship between the position of the paper P on the transport route F and the cumulative paper feed distance. FIGS. 7A to 7D illustrate examples of the state of the paper P on the transport route F. At the moment that the paper P has reached the print starting position after starting the printing operation, the cumulative paper feed distance is reset, hence zero. Then the cumulative paper feed distance gradually increases as a result of the paper feed action performed in accordance with the paper feed distance calculated from the printing data. In FIG. 6, the paper feed distance of each paper feed action is sequentially designated as X1, X2, . . . .

The condition for starting jam detection may be specified in principle as:

X(n-1)≦Xe

Xe<X(n-1)+Xn,

where X(n-1) represents the cumulative paper feed distance up to (N-1) times of paper feed actions, and Xn represents the paper feed distance by the Nth paper feed action. Here, Xe represents the cumulative paper feed distance necessary for the paper front edge Pa to reach the delivery mechanism 40 from the print starting position, and more specifically the value corresponding to the length of the transport route F between the print starting position and the first serrated roller 41. These equations represent the following situation.

The former equation indicates that the current cumulative paper feed distance of the paper P is shorter than the cumulative paper feed distance necessary for the paper front edge Pa to reach the delivery mechanism 40, in other words that the paper front edge Pa has not yet been engaged with the first serrated roller 41. Accordingly, the paper front edge Pa has not yet reached the delivery mechanism 40 at this stage, as shown in FIG. 7A.

The latter equation indicates that upon adding the paper feed distance by the next paper feed action to the current cumulative paper feed distance the updated cumulative paper feed distance exceeds the cumulative paper feed distance necessary for the paper front edge Pa to reach the delivery mechanism 40, in other words that upon performing the next paper feed action the paper front edge Pa can be engaged with the first serrated roller 41 without fail. In the case where the latter equation is satisfied, the paper front edge Pa is supposed to have reached the delivery mechanism 40 as shown in FIG. 7B, provided that the paper P is properly transported along the transport route F. Accordingly, in the subsequent paper transport operation the paper P is outputted to the paper delivery tray by the delivery mechanism 40.

On the other hand, in a case where the paper P is warped or distorted as shown in FIG. 7C, the paper front edge Pa may not have actually reached the delivery mechanism 40 despite that the paper feed action that would allow the paper front edge Pa to reach the delivery mechanism 40 has been performed. In a case where the paper P is further transported in such a state, the paper P may deviate from the transport route F thereby causing a jam as shown in FIG. 7D. In particular, a relatively large space SP is provided downstream of the carriage 10 in the transport direction Dp because the guide and other components have to be kept from contacting the surface of the paper P that has just undergone the printing, and therefore the paper P may intrude into the space SP thus causing a jam.

In this embodiment, therefore, the carriage 10 is made to move without discharging the ink irrespective of whether a printing action is to be performed, at the timing that the paper front edge Pa is supposed to have reached the delivery mechanism 40, in order to detect whether a jam has occurred. Such an arrangement allows prevention of a jam arising from a paper feed action performed while the carriage 10 is not in motion and minimizes, even though a jam occurs, the damage that the paper P and the apparatus may suffer because of the jam.

The jam detection performed by moving the carriage 10 without discharging the ink is also effective when at least a part of the paper P is located in the gap between the carriage 10 and the paper guide 91. Accordingly, the “programmed jam detection” is effective provided that at least a part of the paper P is located so as to oppose the carriage 10 while the carriage 10 is moving. Here, the foregoing condition specifies the cumulative paper feed distance that allows the programmed jam detection to be performed at the timing that the paper front edge Pa has passed the gap and reached the delivery mechanism 40. As will be subsequently described, the experiment performed by the present inventors indicate that an occurrence ratio of a jam caused by contact between the paper P and the carriage 10 becomes the highest at the timing that the paper front edge Pa reaches the printing position PP and at the timing that the paper front edge Pa reaches the delivery mechanism 40 after passing under the carriage 10. A jam that occurs at the former timing can be detected at an early stage and relatively easily settled, however a jam that occurs at the latter timing may provoke a serious problem. The jam detection according to this embodiment is primarily intended for handling a jam that occurs at the latter timing.

In the printing apparatuses actually in use, a slight warp or distortion of the paper P is permissible for transporting the paper P along the transport route F without causing a jam. In other words, even though the paper transport is not properly performed, a jam does not always occur when the cumulative paper feed distance exceeds the value Xe. However, the warp or distortion of the paper P arising from the improper paper transport exceeds a permissible amount, the paper P contacts the carriage 10 thus causing a jam. Therefore it is preferable, from a more realistic view point, to set the cumulative paper feed distance that defines the timing for starting the jam detection at a value slightly longer than Xe corresponding to the distance between the print starting position and the delivery mechanism 40.

Accordingly, a value Xth obtained by adding a predetermined margin amount Xm to the cumulative paper feed distance Xe corresponding to the distance between the print starting position and the delivery mechanism 40 may be adopted as the threshold for starting the jam detection, as shown in FIG. 6. In this case, the realistic condition for starting jam detection can be expressed as the following equation:

X(n-1)Xth<X(n-1)+Xn

However, it is preferable that the paper rear edge Pb does not yet reach the transport nip Nt when the cumulative paper feed distance of the paper P reaches the threshold Xth. More specifically, the threshold Xth may be determined such that a length L4 (FIG. 6) obtained by adding Xth to a length L3 (FIG. 6) of the transport route F between the transport nip Nt and the print starting position becomes shorter than the length Lp of the paper P in the transport direction Dp. In this case, the paper P still remains pinched by the transport nip Nt when the cumulative paper feed distance reaches the threshold Xth, and hence the transport roller 31 can still effectively transport the paper P. Hereunder, the jam detection process will be described referring to FIGS. 3 and 6, and description of a specific method for determining the margin amount Xm will follow thereafter.

In the case where the foregoing condition for starting jam detection is satisfied during a printing action (step S104), the jam detection is started. First, a paper feed action is performed (step S121). The paper feed distance by this paper feed action is the value Xa obtained by subtracting the current cumulative paper feed distance X(n-1) from the threshold Xth, as shown in FIG. 6. Accordingly, the cumulative paper feed distance at this stage becomes equal to the threshold Xth irrespective of the cumulative paper feed distance X(n-1) immediately before the paper feed action. If the paper P is normally transported along the transport route F at this stage, the paper front edge Pa is supposed to reach the delivery mechanism 40 even though the paper P is slightly warped or distorted.

Then the carriage 10 is moved from the current position to an end position in the direction Y (step S122), and the jam detection is performed on the basis of load fluctuation of the carriage driving mechanism 15 (step S123). In this case, it is preferable to move the carriage 10 to the end position farther from the current position, unless the carriage 10 is located at a central position of the reciprocating stroke in the direction Y. Moving thus the carriage 10 over a longer distance allows the jam detection to be quickly performed.

In the case where load fluctuation is detected during the foregoing process, it is decided that a jam has occurred. This is because the load fluctuation can be regarded as originating from the situation where the paper front edge Pa has not reached the delivery mechanism 40 resulting in the paper P being caught on the transport route F. Accordingly, the paper P is discharged to the paper feed tray 90 on the rear side and the paper removal message is displayed, as in the case where a jam is detected during a printing action (steps S127, S128). It is because, as stated above, the paper P is assured to be pinched by the transport nip Nt when the cumulative paper feed distance of the paper P is equal to the threshold Xth and hence can be discharged to the rear side without fail, that the process is arranged so as to discharge the paper P to the rear side.

In the case where a jam has not been detected at this stage, the carriage 10 is moved to the opposite end position and load is again checked (steps S124, S125). In a case where load fluctuation is detected it is decided that a jam has occurred as above, and the paper P is discharged to the paper feed tray 90 on the rear side and the paper removal message is displayed (steps S127, S128). In contrast, if a jam has not been detected at this stage either, it can be assumed that a jam is unlikely to occur through subsequent paper feed actions. Accordingly, the normal printing operation is to be resumed, prior to which the paper P is moved forward by a paper feed distance determined by subtracting the paper feed distance Xa (=(Xth−X(n-1))) of the step S121 from the paper feed distance Xn calculated from the printing data (Xb in FIG. 6) (step S126). As a result, the paper P is located at a position advanced from the position where the preceding printing action was performed by the normal paper feed distance Xn calculated from the printing data, i.e., the position where the next printing action is to be performed, as shown in FIG. 6. Therefore, upon resuming the printing action in this state the printing operation can be successively performed on the correct position.

A method of determining the margin amount Xm will now be described. Although the margin amount Xm can be calculated from the length of the transport route F, stiffness of the paper P, and the gap between the carriage 10 and the paper guide 91, it is more practical to determine the margin amount Xm through experiments, because the warped or distorted state of the paper vastly varies depending on the situation.

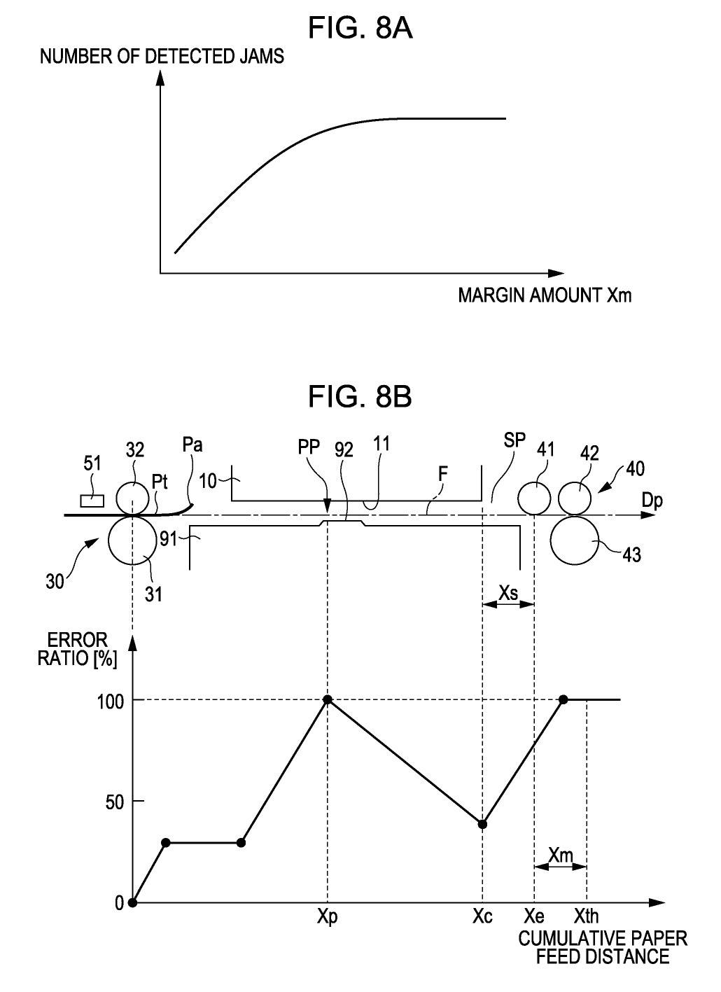

FIGS. 8A and 8B are graphs for explaining the experiment performed to determine the margin amount. Through actual jam detection operations with different margin amounts Xm added to the threshold Xth for starting jam detection, it has proved that the number of detected jams (number of times that the occurrence of a jam has been detected) is smaller in a region where the margin amount is smaller, and the number of detected jams increases with the increase in the margin amount, as shown in FIG. 8A. Accordingly, it is preferable to set a larger margin amount in order to surely detect a jam. However, where the margin amount is larger than a certain level, the number of detected jams no longer increases and remains substantially unchanged. It is therefore senseless to further increase the margin amount. The margin amount Xm may be determined through experiments as described hereunder.

In the experiment performed by the present inventors, a sheet of paper Pt for the experiment, the front edge Pa of which is slightly curled (for example, approximately 5 mm), was introduced into the transport route F and the transport was stopped when the cumulative paper feed distance reached a predetermined value. The carriage 10 was retracted in advance to the position where the carriage 10 was kept from interfering with the paper, and hence the paper Pt was prevented from contacting the carriage 10. Then the carriage 10 was made to move a plurality of times (for example, 10 strokes), and a jam occurrence ratio was measured. As shown in FIG. 8B, it has proved that the jam occurrence ratio becomes higher when the cumulative paper feed distance reaches the value Xp indicating that the paper front edge Pa has reached the printing position PP. This shows that a jam is prone to occur when the curled front edge Pa of the paper Pt is located at the printing position PP, more specifically in the gap between the printing head 11 of the carriage 10 and the backup portion 92 of the paper guide 91. Such a jam can be detected at a relatively early stage on the basis of load fluctuation during a printing action. In addition, since the cumulative paper feed distance of the paper P is still small, the paper P can be discharged to the paper feed tray 90 by reverse rotation of the transport roller 31.

Further, the jam occurrence ratio becomes higher when the cumulative paper feed distance is longer than Xc indicating that the paper front edge Pa is located at a position corresponding to the downstream edge of the carriage 10 in the transport direction Dp, and the jam occurrence ratio becomes substantially 100% in the region where the cumulative paper feed distance is longer than Xe indicating that the paper front edge Pa is engaged with the delivery mechanism 40. This represents the case where, as shown in FIG. 7D, the paper P intrudes into the space SP between the carriage 10 and the delivery mechanism 40, thereby causing a jam. In a case where a jam thus occurs after the paper front edge Pa passes under the carriage 10, the paper rear edge Pb has already passed the transport nip Nt when the jam is detected, and it may no longer be possible to discharge the paper P by the transport roller 31. Since the paper front edge Pa is not yet engaged with the delivery mechanism 40 either, it resultantly becomes impossible to remove the paper P from the apparatus.

In this embodiment, therefore, a value of the cumulative paper feed distance longer than Xe where the jam occurrence ratio becomes substantially 100% but the paper P is still surely engaged with the transport nip Nt is adopted as the threshold Xth, and the programmed jam detection is performed utilizing the condition for starting the jam detection determined on the basis of the threshold Xth thus determined. Such an arrangement prevents occurrence of a jam after the paper rear edge Pb is released from the transport nip Nt, which makes it impossible to remove the paper from the apparatus.

The experiment performed by the present inventors shows that it is preferable that the margin amount Xm is at least a half of a distance Xs (=Xe−Xc), which is the distance between the downstream edge of the carriage 10 in the transport direction Dp and the delivery mechanism 40 (first serrated roller 41). Setting a smaller margin amount Xm may lead to degraded detection performance of a jam that may occur through subsequent paper feed actions. However, an excessively large margin amount Xm leads to a longer paper feed distance at the time of starting jam detection, hence to a longer time for the jam detection. Besides, additional trouble such as a jam because of bringing the paper front edge Pa too close to the delivery mechanism 40 may be incurred. To prevent such a trouble, it is preferable that the margin amount Xm is twice or less as long as the distance Xs. Thus, it is preferable that the margin amount Xm is approximately half to twice the distance Xs, and most preferably the same as the distance Xs. In other words, it is preferable to set the threshold Xth of the cumulative paper feed distance such that the transport distance from the point that the paper front edge Pa has reached the downstream edge of the carriage 10 to the point that the programmed jam detection is started (=Xth−Xc) becomes 1.5 to 3 times, more preferably twice, with respect to the transport distance Xs between the downstream edge of the carriage 10 and the delivery mechanism 40.

In addition, the transport roller 31 has to be capable of discharging the paper P to the paper feed tray 90, in other words at least a part of the paper P has to be engaged with the transport nip, when the cumulative paper feed distance reaches the threshold Xth, as stated above.

In practical use of photo printers of this type, a paper sheet that has caused a jam is often left unremoved after the occurrence of the jam and before the printer is reactivated. The paper discharged to the paper delivery tray is already away from the transport route F and hence not a problem, however in the case where the paper discharged to the paper feed tray 90 is left unremoved until the printer is reactivated, the following trouble may be incurred because such paper is not completely separated from the transport route F.

When the printer is activated, normally an initializing operation is performed that includes racing the rollers such as the transport roller 31 with an additional purpose of functional check. In the case where paper is left in a region on the transport route F between the paper feed roller 21 and the transport roller 31 during this operation, the paper is again introduced into the printer by the transport roller 31. In particular, the paper discharged because of a jam occurrence is often bent or torn, and the paper and the printer may suffer an additional damage if such paper is introduced into the printer. In this embodiment, therefore, the following operation is performed when activating the printer.

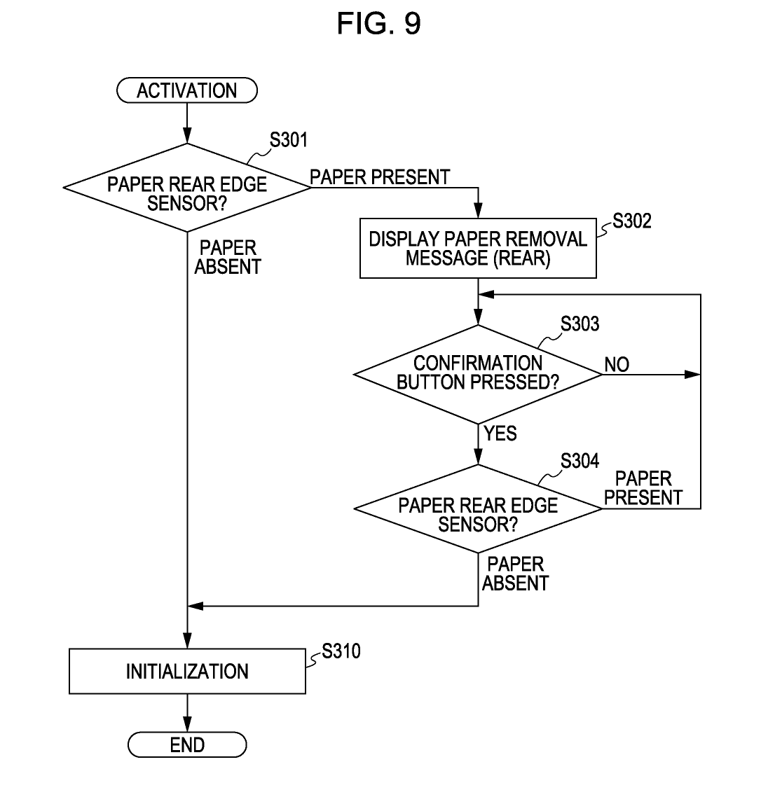

FIG. 9 is a flowchart showing an activation process according to this embodiment. This activation is performed, for example, when the printer is turned on, as well as when the printing operation has ended with error (FIG. 3). First the output of the paper rear edge sensor 51 is checked (step S301), and the normal initialization is performed (step S310) in the case where the paper rear edge sensor 51 detects that paper is absent.

In a case where the paper rear edge sensor 51 detects presence of paper at this stage, it may be construed that jammed paper discharged to the paper feed tray 90 is left on the transport route F. This is because the transport roller 31 is not configured to discharge the paper such that the paper front edge Pa reaches a position upstream of the detection position of the paper rear edge sensor 51 in the transport direction Dp. Further, if the initialization is performed with a paper sheet or a similar sheet-form foreign article placed on the transport route F, whatever the reason may be, a trouble such as a jam often occurs.

Accordingly, in a case where the paper rear edge sensor 51 has detected presence of a paper sheet when the printer is activated, the display unit 72 displays the paper removal message announcing that the paper is left on the rear side (paper feed tray 90) as in the case of a jam (step S302), thereby urging the user to remove the paper. Then the confirmation button is checked (step S303) and once the confirmation button is detected to have been pressed the initialization is performed at this stage if the paper rear edge sensor 51 detects that paper is absent (step S304). In contrast, if the paper rear edge sensor 51 still detects presence of paper the status of the confirmation button is monitored until the paper is removed. Such an arrangement ensures that the initialization is performed without the paper or the sheet-form foreign article left on the transport route F, thereby preventing the trouble described above.

As may be understood from the foregoing description, in this embodiment the carriage 10 and the carriage driving mechanism 15 serve as the carriage and the driving unit of the invention respectively, and integrally serve as the printing unit of the invention. Also, the control unit 80 serves as the controller of the invention.

In this embodiment, further, the position of the transport nip shown in FIG. 6 corresponds to the transport starting position of the invention. Regarding the cumulative paper feed distance from the print starting position utilized for identifying the position of the paper P according to this embodiment, since the transport distance of the invention is based on the transport starting position, the length obtained by adding the cumulative paper feed distance to the length L3 of the transport route F between the transport nip position and the print starting position corresponds to the transport distance, in this embodiment. Further, the length L4 obtained by adding the length L3 of the transport route F between the transport nip and the print starting position to the threshold Xth of the cumulative paper feed distance, which determines the condition for starting jam detection, corresponds to the specified distance of the invention.

It is to be understood that the invention is not limited to the foregoing embodiment, but may be modified in various manners within the scope and spirit of the invention. For example, although the cumulative paper feed distance is calculated from the print starting position where the paper front edge Pa reaches the position right under the carriage 10 according to the embodiment, the starting point of the paper feed distance, i.e., the transport distance of the paper P may be optionally determined. For example, the detection position of the paper rear edge sensor 51 or the transport nip may be adopted as the starting point of the transport distance.

Although the carriage 10 is made to reciprocate for detecting load fluctuation in the jam detection operation in the foregoing embodiment, the carriage 10 may be made to move only one way for the jam detection. Although the traveling speed of the carriage 10 in the jam detection operation is not specifically limited, the carriage 10 may be made to move, for example, at the same speed as in the printing operation. Moving the carriage 10 faster than in the printing operation allows the time required for the jam detection to be shortened. In contrast, moving the carriage 10 slower than in the printing operation allows the damage that the paper P may suffer when a jam occurs to be minimized.

According to the embodiment, the jam detection is performed on the basis of carriage load fluctuation in both of the in-operation jam detection and the programmed jam detection. More specifically, it is decided that a jam has occurred when the output pulse interval of the encoder 14 serving as the index of the traveling speed of the carriage 10 exceeds a predetermined threshold, in other words when the carriage traveling speed falls below a predetermined value. The threshold to be determined for the jam detection is not specifically limited, and a single threshold value may be adopted in common for the respective jam detections, or different thresholds may be individually set. For example, in the case where a lower threshold is set for the programmed jam detection than for the in-operation jam detection jam detection, the paper P is transported during the programmed jam operation under a more severe condition than during the printing operation, and therefore a jam that may subsequently occur can be more accurately detected at an early stage.

Further, since the extent of a decrease in the traveling speed of the carriage 10 originating from contact with the paper P depends on the original traveling speed, in the case where the traveling speed of the carriage 10 can be adjusted in a plurality of levels, different thresholds for the jam detection may be set with respect to each of the speed levels.

Although the jam detection is performed through detecting carriage load fluctuation, more specifically the fluctuation of the traveling speed of the carriage 10 in the foregoing embodiment, the jam detection may be performed by different methods, provided that a change arising from contact between the carriage 10 and the paper P can be detected while the carriage 10 is in motion. For example, the rotation speed of the transport roller 31 or fluctuation of load imposed on the transport motor 35 may be detected for the purpose of jam detection.

Although the foregoing embodiment refers to an ink jet photo printer as an example of the printing apparatus, the invention may be applied to various other apparatuses such as printing apparatuses other than a photo printer or other than an ink jet printer (for example, a thermal printer), provided that the printer includes a carriage that reciprocates with respect to a recording medium.

What is claimed is:

1. A printing apparatus comprising:
a transport mechanism that feeds a recording medium to a printing position along a predetermined transport route;
a printing unit including a carriage disposed so as to oppose the recording medium placed at the printing position and a driving unit that drives the carriage to reciprocate in a main scanning direction different from a direction in which the recording medium is transported along the transport route,
the printing unit being configured to apply a recording agent from the carriage to the recording medium to thereby print an image on the recording medium, and
a controller that causes the driving unit to drive the carriage to make a scanning motion without supplying the recording agent from the carriage when a transport distance of the recording medium from a transport starting position from which it is possible for the transport mechanism to transport the recording medium becomes equal to a predetermined specified distance, and decides whether a jam of the recording medium has occurred on the basis of a physical amount that changes along with the movement of the carriage,
wherein the specified distance corresponds to the transport distance of the recording medium that allows at least a part of the recording medium to oppose the carriage when the carriage makes a scanning motion.

2. The printing apparatus according to claim 1,
wherein the specified distance is shorter than a transport distance of the recording medium necessary for a rear edge of the recording medium in the transport direction to be released from being transported by the transport mechanism.

3. The printing apparatus according to claim 1, further comprising a delivery mechanism that delivers the recording medium that has passed the printing position along the transport route,
wherein the specified distance is longer than a transport distance of the recording medium necessary for a front edge thereof in the transport direction along the transport route to reach the delivery mechanism.

4. The printing apparatus according to claim 3,
wherein the specified distance is determined by adding a predetermined margin amount to the transport distance of the recording medium along the transport route necessary for the front edge thereof in the transport direction to reach the delivery mechanism, and the margin amount is half to twice a distance between a downstream end portion of the carriage in the transport direction and the delivery mechanism.

5. The printing apparatus according to claim 1,
wherein the controller detects a jam while the carriage is being driven by the printing unit to print an image on the recording medium, independently from the jam detection.

6. The printing apparatus according to claim 1, further comprising a detector that detects as a physical amount at least one of a driving torque of the driving unit for driving the carriage, power consumption of the driving unit and a traveling speed of the carriage,
wherein the controller decides that a jam has occurred when the detection result of the detector exceeds a threshold set for the corresponding physical amount.

7. The printing apparatus according to claim 1,
wherein the controller transfers the recording medium in a direction opposite to the transport direction when the controller decides that a jam has occurred as a result of jam detection.

8. A method of controlling a printing apparatus that includes a transport mechanism that feeds a recording medium from a transport starting position to a printing position along a predetermined transport route and a carriage that reciprocates in a main scanning direction different from a direction in which the recording medium is transported, and that applies a recording agent from the carriage to the recording medium placed at the printing position to thereby print an image on the recording medium, the method comprising:
causing the driving unit to drive the carriage to make a scanning motion without supplying the recording agent from the carriage in the case where a transport distance of the recording medium from a transport starting position that enables the transport mechanism to transport the recording medium becomes equal to a predetermined specified distance, and deciding whether a jam of the recording medium has occurred on the basis of a physical amount that changes along with the movement of the carriage,
wherein the specified distance corresponds to the transport distance of the recording medium that allows at least a part of the recording medium to oppose the carriage when the carriage makes a scanning motion.

9. The method according to claim 8, further comprising:
printing an image corresponding to the printing data on the recording medium by alternately repeating transporting the recording medium by using the transport mechanism and causing the carriage to perform a scanning motion, while determining the transport distance by using the transport mechanism on the basis of printing data, and
causing the transport mechanism to transport the recording medium such that the transport distance of the recording medium from the transport starting position becomes equal to the specified distance for detecting a jam, in the case where transporting the recording medium by the transport distance determined on the basis of the printing data results in the transport distance of the recording medium from the transport starting position exceeding the specified distance.
